(19) United States
(12) Patent Application Publication
(10) Pub. No.: US 2009/0290827 A1
(43) Pub. Date: Nov. 26, 2009

(54) NONLINEAR OPTICAL LOOP MIRRORS

(75) Inventors: Ching Tat Chester Shu, Hong Kong (CN); Mei Po Mable Fok, Hong Kong (CN)

Correspondence Address: DARBY & DARBY P.C., P.O. BOX 770, Church Street Station, New York, NY, 10008-0770, US

(73) Assignee: The Chinese University of Hong Kong, Hong Kong (CN)

(21) Appl. No.: 12/469,102

(22) Filed: May 20, 2009

Related U.S. Application Data
(60) Provisional application No. 61/055,327, filed on May 22, 2008.

(51) Int. Cl. G02F 1/01

(52) U.S. Cl. 385/1

(57) ABSTRACT

There are disclosed a nonlinear optical loop mirror. The nonlinear optical loop mirror comprises: an optical coupler which includes a first optical path and a second optical path coupled to each other; and a loop optical path configured to connect the first and second optical paths, wherein the loop optical path is provided with a nonlinear element configured to vary a wavelength of an optical signal and a linear element configured to produce a wavelength dependent time delay for an optical signal. The nonlinear optical loop mirror may function as a delay interferometer for demodulating a differential phase-shift-keying (DPSK) signal.

### TECHNICAL FIELD

The present application relates to optical communications, in particular to a nonlinear optical loop mirror.

### BACKGROUND

A nonlinear optical loop mirror has found many applications in optical signal processing such as optical switching, sampling, demultiplexing, wavelength conversion, pulse shaping, and signal regeneration. FIG. 1 shows a typical configuration of a nonlinear optical loop mirror. As shown in FIG. 1, a conventional nonlinear optical loop mirror 10 comprises: an optical coupler 16 which includes a first optical path 12 and a second optical path 14 coupled to each other; and a loop optical path 18 for connecting the first and second optical paths 12 and 14. A part or the whole of the loop optical path 18 is provided by a nonlinear optical medium NL.

Conventionally, operation of the nonlinear optical loop mirror is based on nonlinear phase modulation due to the nonlinear optical medium NL, which will be described in brief. An optical signal (such as a continuous-wave (CW) light, an optical pulse, etc.) is input into the first optical path 12. If the coupling ratio of the optical coupler 16 is set to be 1:1, the optical signal will be divided into two components having the same power by the optical coupler 16. The two components propagate in the loop optical path 18 clockwise and counterclockwise, respectively. In the nonlinear optical loop mirror 10 shown in FIG. 1, the two components have exactly the same optical path length, and are next subjected to a phase shift for each by the nonlinear optical medium NL. When the two components are then combined at the optical coupler 16, they are equal in power and phase to each other, so that a resultant optical signal obtained by this combination is output from the first optical path 12 but not output from the second optical path 14 as if it is reflected by a mirror. In other applications, if the configuration of the nonlinear optical loop mirror is modified to let the two components be subjected to different phase shifts, the output from the first optical path 12 or the second optical path 14 can be controlled. In particular, the nonlinear optical medium NL can introduce different phase shifts for the two components by using the difference of power levels of the two components. For example, the power of the two components will be different if the optical coupler 16 has a non 1:1 coupling rate or only one component is amplified.

### SUMMARY

In one aspect, there is disclosed a nonlinear optical loop mirror. The nonlinear optical loop mirror may comprise: an optical coupler which includes a first optical path and a second optical path coupled to each other; and a loop optical path configured to connect the first and second optical paths. The loop optical path may be provided with a nonlinear element configured to vary a wavelength of an optical signal and a linear element configured to produce a wavelength dependent time delay for an optical signal.

In the other aspect, there is disclosed a delay interferometer for demodulating a differential phase-shift-keying (DPSK) signal. The delay interferometer may comprise: an optical coupler which includes a first optical path and a second optical path coupled to each other; and a loop optical path configured to connect the first and second optical paths. The loop optical path may be provided with a nonlinear element configured to vary a wavelength of an optical signal and a linear element configured to produce a wavelength dependent time delay for an optical signal.

The nonlinear optical loop mirror according to the present application does not rely on the difference of power levels of the two components in order to control the output. It allows for the same nonlinear element and linear element for the two components and is thus relatively stable since the two components share the same physical path and experience the same environmental disturbances. The nonlinear optical loop mirror as disclosed is applicable for many applications. In particular, it may function as a delay interferometer in detection of DPSK signals at variable bit-rates.

### BRIEF DESCRIPTION OF THE DRAWING

FIG. 1 is a schematic diagram showing a configuration of a nonlinear optical loop mirror in the prior art;

FIG. 2 is a schematic diagram showing a structure of a nonlinear optical loop mirror according to an embodiment of the present application;

FIGS. 3(a) and (b) are eye diagrams of demodulation of RZ DPSK signals with 10-Gb/s and 20-Gb/s, respectively, by using the nonlinear optical loop mirror showing in FIG. 2;

FIG. 4(a) and (b) are graphs showing optical spectra of FWM for the 10-Gb/s and 20-Gb/s RZ DPSK signals, respectively;

FIG. 5 is a schematic diagram showing a nonlinear optical loop mirror in which a tunable optical bandpass filter is provided, according to an embodiment of the present application;

FIG. 6 is a schematic diagram showing a nonlinear optical loop mirror in which an optical circulator is provided, according to an embodiment of the present application.

### DETAILED DESCRIPTION

Hereinafter, a detailed description of implementations will be given with reference to the appended drawings and embodiments.

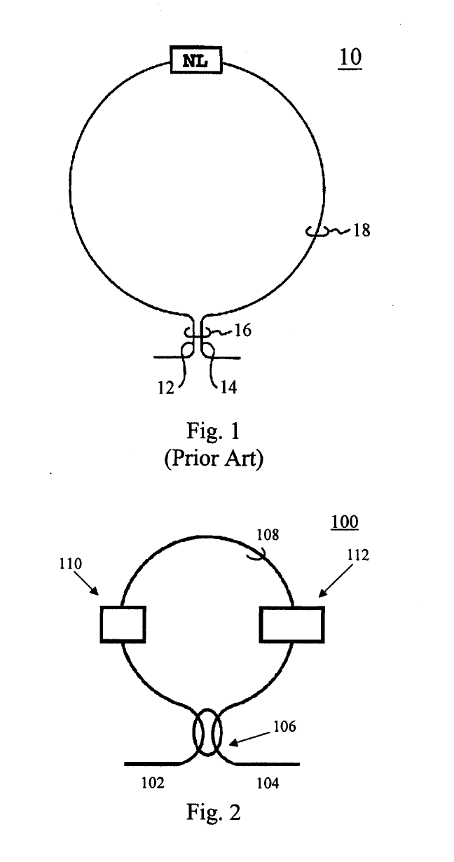

Referring to FIG. 2, a nonlinear optical loop mirror 100 according to an embodiment of the present application is constructed based on the conventional nonlinear optical loop mirror shown in FIG. 1. As shown in FIG. 2, the nonlinear optical loop mirror 100 comprises: an optical coupler 106 which may include a first optical path 102 and a second optical path 104 coupled to each other; and a loop optical path 108 for connecting the first and second optical paths 102 and 104. The loop optical path 108 may be provided with a nonlinear element 110 and a linear element 112. The nonlinear element 110 may be used for varying a wavelength of an optical signal. The linear element 112 may produce a wavelength dependent time delay for an optical signal, that is, introduce an optical delay according to the wavelength of the signal.

When an optical signal enters into the nonlinear optical loop mirror 100 through the first optical path 102, as shown in FIG. 2, it may be split into two components by the optical coupler 106. The two components propagate through a clockwise branch and a counterclockwise branch, respectively. In contrast to the conventional nonlinear optical loop mirror, the nonlinear optical loop mirror 100 according to the present application does not rely on the difference of power levels of the two components in order to control the output. In other words, the power levels of the two components may be identical and an optical coupler 106 with a coupling rate of 1:1 may be used.

Accordingly, the component traveling clockwise (a “clockwise component”) and the component traveling counterclockwise (a “counterclockwise component”) may have the same wavelength and power. The clockwise component first propagates through the nonlinear element 110 and the wavelength thereof may be varied through the processing of the nonlinear element 110. An output of the nonlinear element 110 is then directed to the linear element 112 that produces a wavelength dependent time delay for the clockwise component. Therefore, this component being processed by the nonlinear element 110 and the linear element 112 may have a variable optical delay dependent on the variation of the wavelength produced by the nonlinear element 110. On the other hand, the counterclockwise component will travel in turn through the linear element 112 and the nonlinear element 110. It can be understood that, since the wavelength of the counterclockwise component before propagating through the linear element 112 is fixed, this component being processed by the linear element 112 and the nonlinear element 110 may have a fixed optical delay. The two components may then meet again at the optical coupler 106. The counterclockwise component which has a fixed optical delay and the clockwise component which has a variable optical delay interfere at the optical coupler 106.

In an embodiment of the present application, the nonlinear optical loop mirror 100 as described with respect to FIG. 2 may be used as a delay interferometer in a tunable bit-rate differential phase-shift-keying (DPSK) demodulator. In this embodiment, the nonlinear element 110 of the nonlinear optical loop mirror 100 may be an element which can initiate a four-wave mixing (FWM). Alternatively, the nonlinear element 110 can also change the wavelength of an optical signal by other means, such as a nonlinear phase modulation, a sum/difference frequency generation, etc. In the present embodiment, the nonlinear element 110 may be one selected from a plurality of silica or non-silica based nonlinear optical fibers, or nonlinear optical crystals, or nonlinear semiconductor-based or glass-based waveguides. In a specific example, the nonlinear element 110 may be a dispersion flattened photonic crystal fiber (PCF). In this embodiment, the linear element 112 may be a highly dispersive fiber, or a dispersive semiconductor-based or glass-based waveguide. In a specific example, the linear element 112 may be a group velocity dispersion (GVD) medium for introducing the GVD, such as a standard single mode fiber. The optical coupler 106 may be selected from various optical couplers. In an illustrative example, it may be a 3-dB coupler which has a coupling ratio of 1:1 . However, a coupler with a different coupling rate may also be used. In this case, a unidirectional optical amplifier may be added such that the two components have nearly identical power levels. In the following, the nonlinear optical loop mirror 100 in which the nonlinear element 110 using the FWM, the linear element 112 using the GVD and the optical coupler 106 having a coupling ratio of 1:1 will be described in detail.

In the embodiment in which the nonlinear optical loop mirror 100 is used as a delay interferometer in a DPSK demodulator, the signal to be processed by the nonlinear optical loop mirror 100 may comprise an input signal and a control signal. In an illustrative example, the control signal may be a tunable CW light. As stated above, when the signal to be processed including the input signal and the control signal enters into the nonlinear optical loop mirror 100 through the first optical path 102, the signal to be processed is divided into a clockwise component and a counterclockwise component with the same wavelength and power.

The clockwise component first propagates through the nonlinear element 110 where the FWM occurs between the control signal and the input signal. In the process of the FWM, a dynamic index grating may be created through beating between the input signal and the control signal. The grating then scatters or modulates the control signal. During the scattering or modulation process, the wavelength of the clockwise component may be varied and the phase and amplitude information of the input signal may be transferred. Therefore, the FWM may preserve both phase and amplitude information of the input signal, and change the wavelength of the clockwise component. An output of the nonlinear element 110 has an optical angular frequency ω_{f}=2ω_{c}−ωₛ, where ω_{c} and ωₛ are the optical angular frequencies of the control signal and the input signal, respectively. Accordingly, the wavelength of the output of the nonlinear element 110 in the clockwise component is variable according to the wavelength of the control signal.

The output of the nonlinear element 110 is then directed to the linear element 112 that introduces a wavelength dependent time delay by the GVD. It can be understood that optical signals with different wavelength propagate at different speeds in a GVD medium due to the difference in refractive index for different wavelengths. Therefore, the propagating time of a signal is dependent on its wavelength launched to the GVD medium, which results in a wavelength dependent optical delay. The combination of the FWM at the nonlinear element 110 and the GVD at the linear element 112 thus forms into a tunable optical delay line inside the nonlinear optical loop mirror 100. By changing the wavelength of the control signal, the amount of optical delay can be varied.

For the counterclockwise component, the GVD is first introduced at the linear element 112 before the FWM takes effect at the nonlinear element 110. It can be understood that the amount of optical delay for the counterclockwise component is fixed since the FWM occurs after the GVD.

At the optical coupler 106, the counterclockwise component which has a fixed optical delay and the clockwise component which has a variable optical delay meet again and interfere. An output signal of the nonlinear optical loop mirror 100 is determined by the relative phase difference between the clockwise and counterclockwise components. It can be understood that, if the two components have the same phase, the interference taking place at the optical coupler 106 may be deemed as a constructive interference (i.e. no output at the second optical path 104); and if the two components are 180° out of phase, the interference taking place at the optical 106 may be deemed as a destructive interference (i.e. no output at the first optical path 102). In other words, a constructive interference occurs at the second optical path 104 and a destructive interference occurs at the first optical path 102. If the two components have a phase difference between 0 and 180°, a part of output will be at first optical path 102 and the other part will be at the second optical path 104.

The relative optical delay Δt between the clockwise and counterclockwise components is given by Eq (1) as following:

Δt=|λ_{f}−λₛ|×D_{GVD}×L_{GVD}=2|λ_{c}−λₛ|×D_{GVD}×L_{GVD} (1)

Where λ_{f}, λₛ, and λ_{c} are the wavelength of the output of the nonlinear element 110, the input signal and the control signal, D_{GVD} and L_{GVD} are the dispersion and the length of the linear element 112, respectively.

Hereafter, it will be discussed how the nonlinear optical loop mirror 100 works as a delay interferometer in demodulating DPSK signals with variable bit-rates.

With the development of optical communications, advanced modulation formats are being explored to carry data signals in optical fibers. In particular, a DPSK modulation format is attracting much interest. For a detection of DPSK signals, a demodulation approach is required to convert phase modulation into intensity modulation. Examples of the demodulation approaches include the use of a phase-shifted fiber Bragg grating, an optical discriminator filter, an all-fiber delay-line interferometer, a birefringent fiber loop, and so on. In other words, a common way for the detection of a DPSK signal is to use a component called a “delay interferometer” that converts the phase information into intensity information before the signal is directed to an optical receiver. In addition, the demodulation of a DPSK signal requires the interference between adjacent bits. However, a limitation of the existing “delay interferometer” is that it is not tunable, that is, it is built to operate at a fixed data bit-rate of communication.

It is known that the demodulation of a DPSK signal requires the interference between adjacent bits. In particular, the interference between the adjacent bits may convert the phase information in a DPSK signal into intensity information. In the nonlinear optical loop mirror 100 of an embodiment of the present application, the signal to be processed is split into two counter propagating components. The clockwise component has a variable delay, while the counter-clockwise component has a fixed delay. The delay may be adjusted such that the two counter-propagating components have a relative delay (delay difference) equal to one-bit period for a specific DPSK signal. When the two counter-propagating components meet again at the optical coupler 106, interference occurs. Since the relative delay between the two counter-propagating components is one-bit, interference between the adjacent bits is achieved.

In a specific example, a 64-m dispersion flattened photonic crystal fiber (PCF) may be used as the nonlinear element 110 to introduce the FWM between the input signal and the control signal. It is experimentally demonstrated that a wavelength variation of 20 nm is possible between the signal to be processed and the output of the nonlinear element 110 owing to low-dispersion and dispersion flattened characteristics of the PCF to make the conversion efficiency to be within a 3-dB variation. Hence, a large tuning range may be supported since the wavelength variation can essentially be tuned from 0 to 20 nm. In addition, the nonlinear optical loop mirror 100 may use, for example, a 600-m standard single mode fiber as the linear element 112 to provide an approximately 10 ps/nm GVD at the wavelength range of interest.

A DPSK signal to be demodulated as the input signal is first combined with a CW light from a tunable laser. The combined signal is launched to the nonlinear optical loop mirror 100 in which the FWM and GVD take place. It is known that since the FWM occurs more effectively for the control signal and input signal with high power, the combined signal may be boosted by a fiber amplifier (not shown) before launching to the nonlinear optical loop mirror 100. It can be understood that different bit rates are associated with different bit periods. To demodulate the DPSK signal, the relative delay between the two interference branches of the nonlinear optical loop mirror 100 should thus match with the bit period for a one-bit demodulation. Therefore, by adjusting the wavelength of the control signal, the relative delay between the two branches of the nonlinear optical loop mirror 100 is variable so that demodulation at different bit rates for DPSK signals is achieved. The nonlinear optical loop mirror according to an embodiment of the present application may thus provide continuous optical delay between two interfering branches. In an illustrative example that the nonlinear optical loop mirror may produce up to 20 nm variation between the signal to be processed and the FWM output as well as the approximately 10 ps/nm GVD, a 200 ps relative delay can be achieved. Thus, the nonlinear optical loop mirror can serve as a delay interferometer in a DPSK demodulator for any bit-rate above 5 Gb/s.

In an illustrative example, a 10-Gb/s RZ DPSK signal at 1553.8 nm is used as the input signal. The control signal is tuned to a wavelength of 1548.8 nm. The wavelength difference of the DPSK input signal and the CW control is 5 nm and thus a relative delay of Δt=100 ps is obtained according to Eq. (1). The delay is of the amount required for demodulating a 10-Gb/s DPSK signal.

As another illustrative example, to investigate the performance of the nonlinear optical loop mirror in demodulating a DPSK signal at variable bit-rates, a 20-Gb/s RZ DPSK signal is used as the input signal. In this example, the wavelength of the control signal is tuned to be 1551.28 nm. The wavelength difference between the input signal and the control signal is 2.5 nm, resulting in Δt=50 ps that can be used for the demodulation of a 20-Gb/s DPSK signal.

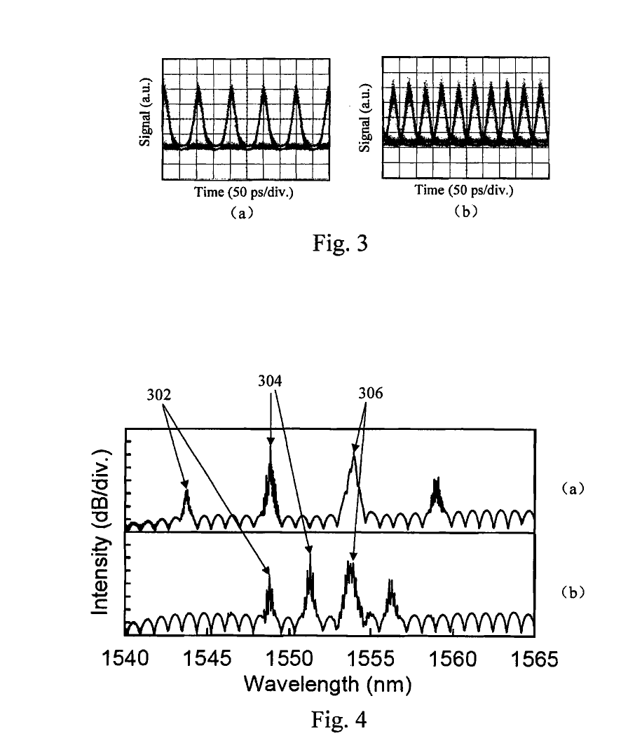

FIGS. 3 a) and (b) show, respectively, eye diagrams of the resultant signals of the demodulation of RZ DPSK signals with 10-Gb/s and 20-Gb/s by using the nonlinear optical loop mirror 100 of an embodiment of the present application. Since each of the widely opened eye diagrams in FIGS. 3(a) and (b) indicates a relatively large signal-to-noise ratio of the demodulation of RZ DPSK signal, it is shown the capability of tunable bit-rate operation of DPSK demodulation with the proposed nonlinear optical loop mirror. The optical spectra, for the 10-Gb/s and 20-Gb/s RZ DPSK signals, of outputs 302 from the nonlinear element 110 is shown in FIGS. 4(a) and (b), respectively, to show the FWM between the input signal 304 and the control signal 306.

It can be observed in FIGS. 4(a) and (b) periodic ripples owing to a birefringence of the PCF as the nonlinear element 110. It can be understood that a PCF with low birefringence can be used to eliminate the effect. Alternatively, a well known process of polarization adjustment can be used to minimize the effect of the birefringence on the demodulated DPSK signal. It is experimentally demonstrated, in the demodulation of 10-Gb/s and 20-Gb/s RZ DPSK signals, that an error-free detection (a bit-error-rate (BER) performance is below 10⁻⁹) may be obtained at a received power level of −21 dBm and no error floor is observed.

Besides the demodulation of RZ DPSK signals, it is experimentally demonstrated that a NRZ DPSK signal can be demodulated with different bit-delays and without observing error floor.

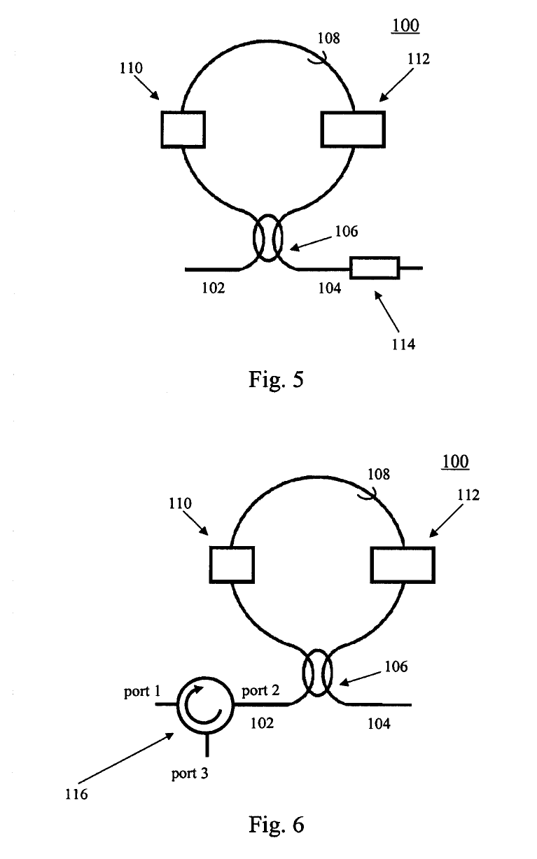

It can be understood that some additional components may be provided in the nonlinear optical loop mirror 100 to improve the performance of demodulating DPSK signals. For example, in order to separate the FWM output from the both the input signal and the control signal, a tunable optical bandpass filter 114 may be provided at the second optical path 104 for filtering out the demodulated DPSK signal, as shown in FIG. 5. In addition, it is known that a balanced detection is desired and can only be achieved when the demodulated outputs are obtained from both optical paths 102 and 104. Thus, in order to obtain a balanced detection, an optical circulator may be provided at the first optical path 102. FIG. 6 shows this configuration. The optical circulator 116 is a three-port device that allows an optical signal to travel in only one direction, i.e. from port 1 to port 2, then from port 2 to port 3. It allows the optical signal (port 1) to enter the nonlinear optical loop mirror (port 2), while the output from the nonlinear optical loop mirror (port 2) will be collected at port 3. With the setup as shown in FIG. 6, a balanced detection can be supported.

Although it has been discussed that the nonlinear optical loop mirror according to the present application is applied in the demodulation of the DPSK signals, it can be understood that it also has some other functions. For example, with control of the tunable delay, the nonlinear optical loop mirror can also function as a bit-rate multiplier for RZ signals. It is known that a bit-rate multiplier requires a temporal interleaving of two lower bit rate inputs. The conventional approach is to split the signal into two branches and then recombine the branches after introducing a half-bit relative delay between them. The delay is normally determined by the length of fiber and is only slightly tunable through stretching of the fiber. With the nonlinear optical loop mirror according to the present application, it is possible to split the signal into two branches, while the delay is governed by the nonlinear element 110 and the linear element 112 as described before. By adjusting the wavelength to obtain a half-bit delay, a bit-rate multiplier for RZ signals is obtained. Besides, all-optical reshaping (that is, to reshape a temporal profile of a signal.) or conversion among different data formats (that is, a conversion between different data formats, e.g. RZ, NRZ, CSRZ, etc.) can be potentially achieved with the nonlinear optical loop mirror since the temporal and spectral properties of the output depend on the amount of overlap between the two branches.

Although the above descriptions include many specific arrangements and parameters, it should be noted that these specific arrangements and parameters only serve to illustrate one embodiment of the present application. This should not be considered as the limitations on the scope of the invention. It can be understood by those skilled in the art that various modifications, additions and substitutions may be made thereto without departing from the scope and spirit of the present invention. For example, as described above, a CW light is selected as the control signal of which the wavelength is varied to control the variation of the wavelength of the clockwise component. However, other type of signal can be used as the control signal. For example, a pulsed optical signal can be used if a return-to-zero data output after the DPSK demodulation is targeted to be obtained. Therefore, the scope of the present invention should be construed on the basis of the appended claims.

1. A nonlinear optical loop mirror comprising:
an optical coupler which includes a first optical path and a second optical path coupled to each other; and
a loop optical path configured to connect the first and second optical paths,
wherein the loop optical path is provided with a nonlinear element configured to vary a wavelength of an optical signal and a linear element configured to produce a wavelength dependent time delay for an optical signal.

2. The nonlinear optical loop mirror according to claim 1, wherein the nonlinear element is configured to initiate a four-wave mixing (FWM).

3. The nonlinear optical loop mirror according to claim 2, wherein the nonlinear element is a dispersion flattened photonic crystal fiber (PCF).

4. The nonlinear optical loop mirror according to claim 1, wherein the linear element is configured to produce a group velocity dispersion (GVD).

5. The nonlinear optical loop mirror according to claim 4, wherein the linear element is a standard single mode fiber.

6. The nonlinear optical loop mirror according to claim 2, wherein a signal to be processed by the nonlinear optical loop mirror comprises an input signal and a control signal.

7. The nonlinear optical loop mirror according to claim 6, wherein the control signal is a tunable CW control light.

8. A delay interferometer for demodulating a differential phase-shift-keying (DPSK) signal, comprising:
an optical coupler which includes a first optical path and a second optical path coupled to each other; and
a loop optical path configured to connect the first and second optical paths,
wherein the loop optical path is provided with a nonlinear element configured to vary a wavelength of an optical signal and a linear element configured to produce a wavelength dependent time delay for an optical signal.

9. The delay interferometer according to claim 8, wherein the nonlinear element is configured to initiate a four-wave mixing (FWM).

10. The delay interferometer according to claim 9, wherein the nonlinear element is a dispersion flattened photonic crystal fiber (PCF).

11. The delay interferometer according to claim 8, wherein the linear element is configured to produce a group velocity dispersion (GVD).

12. The delay interferometer according to claim 11, wherein the linear element is a standard single mode fiber.

13. The delay interferometer according to claim 9, wherein a signal to be processed by the delay interferometer comprises the DPSK signal and a control signal.

14. The delay interferometer according to claim 13, wherein the control signal is a tunable CW control light.

15. The delay interferometer according to claim 8, further comprising a tunable optical bandpass filter provided at the second optical path.

16. The delay interferometer according to claim 8, further comprising an optical circulator provided at the first optical path.
